(19) United States
(12) Patent Application Publication
(10) Pub. No.: US 2004/0156302 A1
(43) Pub. Date: Aug. 12, 2004

(54) Optical head

(75) Inventors: Hideki Nakata, Soraku-gun (JP); Hironori Tomita, Ikoma-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., LTD., Kadoma-shi (JP)

(21) Appl. No.: 10/751,188

(22) Filed: Dec. 30, 2003

(30) Foreign Application Priority Data
Jan. 7, 2003 (JP) 2003-000956

(51) Int. Cl. G11B 7/135

(52) U.S. Cl. 369/112.17; 369/112.19

(57) ABSTRACT

An optical head is provided so as to include one prism having a wavelength separation function for reducing the number of steps for adjustment. The optical head includes a first light source, a second light source, a third light source and a beam splitter. The beam splitter includes a first prism, a second prism, a third prism, a fourth prism, a first optical film, a second optical film, a third optical film and a fourth optical film. The first to the fourth optical films have desired optical characteristics for allowing the light beam from the first light source that enters into the first prism and has a first wavelength, the light beam from the second light source that enters into the second prism and has a second wavelength and the light beam from the third light source that enters into the third prism and has a third wavelength to pass through or for reflecting these light beams.

### BACKGROUND OF THE INVENTION

1. Field of the Invention

The present invention relates to an optical head that is used for a disk recording/reproducing apparatus that records and reproduces information optically by projecting a light spot on a disk-shaped recording medium.

2. Related Background Art

In recent years, disk recording/reproducing apparatuses have been applied for recording/reproducing with respect to a disk-shaped recording medium such as CD-ROM, CD-R, MD, DVD-RAM and Blu-ray Disk, and their applications have increased in diversity while being required increasingly to have a high density, high performance, high quality and high added-value as well as a small size and low cost. Particularly, for disk recording/reproducing apparatuses capable of recording, it has been required for one apparatus to deal with recording and reproducing with respect to disks according to a plurality of types of specifications, and also demands for such apparatuses to be applied to portable and vehicle-installed applications are strong and will be increased. Therefore, such apparatuses will be required to have further miniaturization, slimming-down and higher performance.

Conventionally, many reports have been made for technology concerning an optical head provided in a disk recording/reproducing apparatus (See JP 2000-76698 A, for example). The following describes a conventional optical head for a magneto-optical disk, with reference to drawings.

FIG. 23 schematically shows a configuration of the conventional optical head 90, and FIG. 24 schematically shows a configuration of a photodetector 95 provided in the conventional optical head 90. In FIG. 23, reference numeral 1 denotes a semiconductor laser that emits a light beam of 750 nm to 850 nm, 2 denotes a semiconductor laser that emits a light beam of 600 nm to 700 nm and 3 denotes a semiconductor laser that emits a light beam of 400 nm to 500 nm. Reference numeral 5 denotes a prism having a wavelength separation film 4, and 7 denotes a prism having a wavelength separation film 6. Reference numeral 8 denotes a collimator lens, 10 denotes a polarized beam splitter having a polarization separation film 9, 11 denotes a λ/4 plate, 12 denotes an objective lens, 13 denotes an information recording medium, 14 denotes a detection lens that generates astigmatism and 95 denotes a photodetector that detects a servo signal and an RF signal. In FIG. 23, reference numerals 16 and 17 denote a front focus and a back focus, respectively, due to the astigmatism generated by the detection lens 14. A light-receptive face 15a formed on the photodetector 95 is located substantially at a midpoint between the front focus 16 and the back focus 17 that are arranged along a Z direction indicated in FIG. 23.

FIG. 24 specifically shows the configuration of the photodetector 95. In FIG. 24, reference numerals 18, 19, 20 and 21 denote light-receptive regions, and 22 denotes a light spot formed on the light-receptive regions. The amounts of all of light received at the light-receptive regions 18, 19, 20 and 21 are added by an adder 23 so as to detect an RF signal. In addition, a differential signal between a signal obtained by adding the amounts of light received at the light-receptive regions 18 and 19 and a signal obtained by adding the amounts of light received at the light-receptive regions 20 and 21 is produced by a subtracter 24, which allows the detection of a focus error signal by a so-called astigmatism method. Furthermore, a differential signal between a signal obtained by adding the amounts of light received at the light receptive regions 19 and 20 and a signal obtained by adding the amounts of light received at the light receptive regions 18 and 21 is produced by a subtracter 250, which allows the detection of a tracking error signal by so-called a push-pull method.

FIGS. 25A to 25C each shows a shape of the light spot formed through the detection lens 14 on the light-receptive face 15a of the photodetector 95.

FIG. 25A shows a shape of the light spot formed on the light-receptive face 15a of the photodetector 95 when the information recording medium 13 and the objective lens 12 are close to each other, and FIG. 25C shows a shape of the light spot formed on the light-receptive face 15a when the information recording medium 13 and the objective lens 12 are away from each other. FIG. 25B shows a shape of the light spot formed on the light-receptive face 15a that is substantially a middle state between FIG. 25A and FIG. 25C, which is in a state of just focus.

The following describes an operation of the thus configured conventional optical head 90.

A light beam (infrared light) with a wavelength of 750 nm to 850 nm that is emitted from the semiconductor laser 1 is reflected from the wavelength separation film 4 to be used for reproducing from CDs or recording on CD-Rs. At this time, the wavelength separation film 4 has a configuration, as shown in a curve C91 of FIG. 26, such that a light beam having a wavelength not shorter than about 700 nm is reflected therefrom and a light beam having a wavelength shorter than 700 nm is allowed to pass through. A light beam (infrared light) of 600 nm to 680 nm that is emitted from the semiconductor laser 2 passes through the wavelength separation film 4 to be used for reproducing from DVD-ROMs and recording/reproducing with respect to DVD-RAMs, DVD-Rs, DVD-RWs and the like. A light beam (blue light) of 400 nm to 500 nm that is emitted from the semiconductor laser 3 is reflected from the wavelength separation film 6 to be used for recording/reproducing with respect to optical disks for blue laser. At this time, the wavelength separation film 6 has a configuration, as shown in a curve C92 of FIG. 26, such that a light beam having a wavelength not shorter than 500 nm is allowed to pass through.

A divergent light beam that is emitted from any one of the semiconductor lasers 1 to 3 enters into the collimator lens 8 to be converted into a parallel light beam, and passes through the polarization separation film 9 formed in the beam splitter 10 to enter into the λ/4 plate 11. Polarizing directions of the semiconductor lasers 1 to 3 are set at directions parallel to the sheet of FIG. 23 (directions indicated by arrows of FIG. 23), so as to allow a divergent light beam to pass through the polarization separation film 9. The parallel light beam as linear polarized light that is incident on the λ/4 plate 11 is changed as circular polarized light, which enters into the objective lens 12 so as to form a light spot with a diameter of 1 μm or less on the information recording medium 13. Then, a light beam reflected from the information recording medium 13 travels along a reversed path so as to enter into the λ/4 plate 11.

When entering into the λ/4 plate 11, the light beam is in the form of circular polarized light. However, after passing through the λ/4 plate 11, it becomes linear polarized light that is polarized along a direction perpendicular to the sheet of FIG. 23, which is then reflected from the polarization separation film 9 to enter into the detection lens 14. A first surface of the detection lens 14 is a convex lens and a second surface thereof is so-called a cylindrical convex lens whose cylindrical axis is set at about 45 degrees relative to a plane parallel to the sheet of FIG. 23. Therefore, astigmatism is generated between a direction of the cylindrical axis and a direction perpendicular to the cylindrical axis (See FIGS. 25A to 25C). The light beam passing through the detection lens 14 enters into the photodetector 95.

The focus servo of the objective lens 12 would be converged to an intersection point FP of a focus error signal S91 (a so-called S-shaped signal) output from the subtracter 24 and the GND as shown in FIG. 27A. Similarly, the tracking error signal of the objective lens 12 would be converged to an intersection point TP of the tracking error signal output from the subtracter 250 and the GND as shown in FIG. 27B.

Furthermore, an RF signal can be detected based on a change in the amount of light reflected from the information recording medium 13, which is carried out by the calculation of a signal output from the adder 23.

In the above-described conventional configuration, however, two prisms including the prism 5 and the prism 7 need to be provided in order to achieve a wavelength separation function, which makes it impossible to realize the miniaturization and slimming-down of the optical head. Additionally, there are problems of difficulties in attaching the two prisms 5 and 7 to an optical mount (not illustrated) with accuracy and in maintaining the accuracy because of temperature change. Furthermore, this configuration requires two prisms, thus making it impossible to lower the cost.

In addition, the two prisms 5 and 7 have to be provided, which increases a distance between a position of the semiconductor lasers 1 and 2 and a position of the collimator lens 8. For that reason, the amount of light from the semiconductor lasers 1 and 2 that can be passed into the collimator lens 8 is reduced, which leads to a shortage of a recording power or leads to a problem that another high-power semiconductor laser should be used for making up for the shortage, thus increasing the cost substantially. Moreover, the use of a high-power semiconductor laser increases a laser current, which increases a heat quantity from the semiconductor laser itself, thus degrading a reliability of the semiconductor laser itself.

### SUMMARY OF THE INVENTION

Therefore, with the foregoing in mind, it is an object of the present invention to provide a small and high-precision optical head configured with three light sources, in which one prism having a wavelength separation function is provided for the purpose of substantially reducing the number of steps for adjustment as well as miniaturization, slimming-down and low power consumption, so as to realize a small and high-precision disk recording/reproducing apparatus as well as high-precision recording/reproducing characteristics.

An optical head according to the present invention includes: a first light source having a first wavelength and a first optical axis; a second light source having a second wavelength different from the first wavelength and a second optical axis intersecting with the first optical axis; a third light source having a third wavelength different from the first wavelength and the second wavelength and a third optical axis that is substantially parallel to the first optical axis; and a beam splitter provided for allowing light beams from the first light source, the second light source and the third light source to pass through or reflecting these light beams, the beam splitter being surrounded with the first light source, the second light source and the third light source. The beam splitter includes: a first prism that is provided so that the light beam from the first light source enters therein; a second prism that is provided so that the light beam from the second light source enters therein; a third prism that is provided so that the light beam from the third light source enters therein; a fourth prism that is provided between the first prism and the third prism so as to be opposed to the second prism; a first optical film that is formed between the first prism and the second prism; a second optical film that is formed between the second prism and the third prism; a third optical film that is formed between the third prism and the fourth prism; and a fourth optical film that is formed between the fourth prism and the first prism. The first to the fourth optical films have desired optical characteristics for allowing the light beam from the first light source that enters into the first prism and has the first wavelength, the light beam from the second light source that enters into the second prism and has the second wavelength and the light beam from the third light source that enters into the third prism and has the third wavelength to pass through or for reflecting these light beams.

Another optical head according to the present invention includes: a first light source having a first wavelength and a first optical axis; a second light source having a second wavelength different from the first wavelength and a second optical axis intersecting with the first optical axis; a third light source having a third wavelength different from the first wavelength and the second wavelength and a third optical axis that is substantially parallel to the first optical axis; and a beam splitter provided for allowing light beams from the first light source, the second light source and the third light source to pass through or reflecting these light beams, the beam splitter being surrounded with the first light source, the second light source and the third light source. The beam splitter includes: a first prism that is provided so that the light beam from the first light source enters therein; a second prism that is provided so that the light beam from the second light source enters therein; a third prism that is provided so that the light beam from the third light source enters therein; a first optical film that is formed between the first prism and the second prism; and a second optical film that is formed between the first prism and the third prism. The first optical film has first optical characteristics for allowing the light beam from the first light source that enters into the first prism and has the first wavelength and the light beam from the second light source that enters into the second prism and has the second wavelength to pass through or for reflecting these light beams, and the second optical film has second optical characteristics, which are different from the first optical characteristics, for allowing the light beam from the first light source that enters into the first prism and has the first wavelength, the light beam from the second light source that enters into the second prism and has the second wavelength and the light beam from the third light source that enters into the third prism and has the third wavelength to pass through or for reflecting these light beams.

According to the present invention, a small and high-precision optical head configured with three light sources can be provided, in which one prism having a wavelength separation function is provided for enabling a substantial reduction in the number of steps for adjustment as well as miniaturization, slimming-down and low power consumption, so that a small and high-precision disk recording/reproducing apparatus as well as high-precision recording/reproducing characteristics can be realized.

### BRIEF DESCRIPTION OF THE DRAWINGS

FIG. 1 schematically shows an optical path of an optical head in Embodiment 1.

FIG. 2 shows a configuration of a wavelength separation prism in Embodiment 1.

FIG. 3 schematically shows the wavelength separation prism of the optical head in Embodiment 1.

FIG. 4 schematically shows film characteristics of wavelength separation films in Embodiment 1.

FIG. 5 schematically shows a photodetector in the optical head in Embodiment 1.

FIGS. 6A to 6C schematically show astigmatism on the photoreceptor in Embodiment 1.

FIG. 7A is a graph showing a focus error signal of the optical head in Embodiment 1, and FIG. 7B schematically shows a tracking error signal.

FIG. 8 schematically shows a collimator lens and a wavelength separation prism of another optical head in Embodiment 1.

FIG. 9 schematically shows a collimator lens and a wavelength separation prism of still another optical head in Embodiment 1.

FIG. 10 schematically shows a method for manufacturing a wavelength separation prism of an optical head in Embodiment 1.

FIG. 11 schematically shows a wavelength separation prism of a further optical head in Embodiment 1.

FIG. 12 schematically shows film characteristics of the wavelength separation films in Embodiment 1.

FIG. 13 schematically shows a wavelength separation prism of a still further optical head in Embodiment 1.

FIG. 14 schematically shows film characteristics of the wavelength separation films in Embodiment 1.

FIG. 15 explains a configuration of a modification example of the wavelength separation prism in Embodiment 1.

FIG. 16 shows a configuration of an optical head in Embodiment 2.

FIG. 17A schematically shows a wavelength separation prism in Embodiment 3 and FIG. 17B is a perspective view for the same.

FIG. 18 is a conceptual diagram of light intensity in Embodiment 3.

FIG. 19 schematically shows an optical path of an optical head in Embodiment 4.

FIG. 20A shows a configuration of a wavelength separation prism in Embodiment 4 and FIG. 20B is an exploded view for the same.

FIG. 21 schematically shows film characteristics of wavelength separation films in Embodiment 4.

FIG. 22A shows a configuration of another wavelength separation prism in Embodiment 4 and FIG. 22B schematically shows film characteristics of the same.

FIG. 23 schematically shows an optical path of the conventional optical head.

FIG. 24 schematically shows a photodetector provided in the conventional optical head.

FIGS. 25A to C schematically show astigmatism on a photoreceptor provided in the conventional optical head.

FIG. 26 schematically shows film characteristics of wavelength separation films provided in the conventional optical head.

FIG. 27A is a graph showing a focus error signal of the conventional optical head and FIG. 27B is a graph showing its tracking error signal.

### DETAILED DESCRIPTION OF THE INVENTION

In the optical head according to the present embodiments, the first to the fourth optical films have desired optical characteristics for allowing the light beam from the first light source that enters into the first prism and has the first wavelength, the light beam from the second light source that enters into the second prism and has the second wavelength and the light beam from the third light source that enters into the third prism and has the third wavelength to pass through or for reflecting these light beams. Therefore, in the optical head configured with the three light sources, a prism having a wavelength separation function can be configured integrally. As a result, the number of steps for adjustment can be reduced substantially and also miniaturization, slimming-down and low power consumption can be realized, so that a small and high-precision optical head as well as a small and high-precision recording/reproducing apparatus can be realized.

In this embodiment, it is preferable that the first to the fourth prisms have a substantially triangular prism form, and the beam splitter has substantially a hexahedral form that is formed with a bottom face, a top face and one of the side faces of each of the first to the fourth prisms.

It is preferable that the first optical film and the third optical film are formed on the same plane and have the same optical characteristics, and the second optical film and the fourth optical film are formed on the same plane and have the same optical characteristics.

It is preferable that the first wavelength, the second wavelength and the third wavelength respectively are three different wavelengths selected from four types including 750 nm to 850 nm, 600 nm to 700 nm, 400 nm to 500 nm and 300 nm to 400 nm.

It is preferable that the first optical axis and the second optical axis intersect at substantially right angles, and the first optical axis and the third optical axis form an angle of substantially 180 degrees.

It is preferable that a reflectance or a transmittance of each of the first to the fourth optical films is changed in accordance with a wavelength of an incident light beam.

It is preferable that the first optical film and the third optical film have optical characteristics such that a light beam having a wavelength not shorter than a first threshold value is allowed to pass through and a light beam having a wavelength shorter than the first threshold value is reflected therefrom, and the second optical film and the fourth optical film have optical characteristics such that a light beam having a wavelength not shorter than a second threshold value that is higher than the first threshold value is reflected therefrom and a light beam having a wavelength shorter than the second threshold value is allowed to pass through.

It is preferable that a reflection film for reducing an amount of light at substantially a center portion of a light beam is formed on at least one of the first to the fourth prisms.

It is preferable that the reflection film has any one of a strip shape, a circular shape and an oval shape.

It is preferable that a light beam diameter restriction film that restricts a diameter of a light beam emitted from the beam splitter is formed on the beam splitter.

It is preferable that the first to the fourth prisms are made of at least one selected from the group consisting of glass, resin, and transparent ceramic.

Preferably, the above-stated optical head further includes a collimator lens that is provided for converting the light beams emitted from the first to the third light sources into parallel beams, and the collimator lens is provided so as to be attached to the fourth prism.

Preferably, the above-stated optical head further includes collimator lenses that are provided for converting the light beams emitted from the first to the third light sources into parallel beams, and the collimator lenses are disposed between the first light source and the first prism, between the second light source and the second prism and between the third light source and the third prism.

It is preferable that each of the first to the third prisms has an incident surface that is formed so as to cancel astigmatisms possessed by the light sources, and the fourth prism has an emission surface that is formed so as to cancel the astigmatisms possessed by the light sources.

The following describes embodiments of the present invention, with reference to the drawings.

Embodiment 1

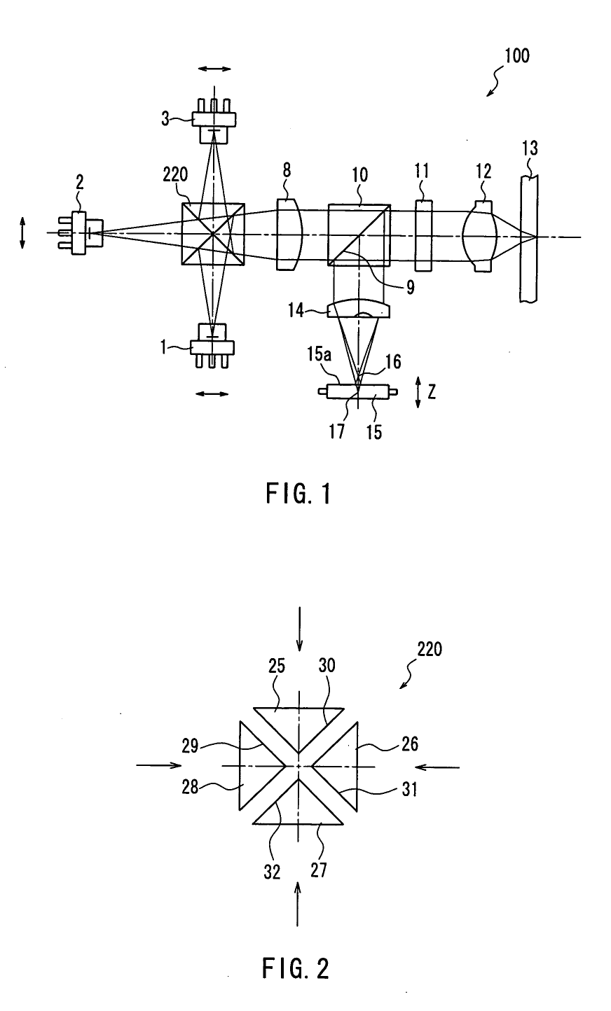

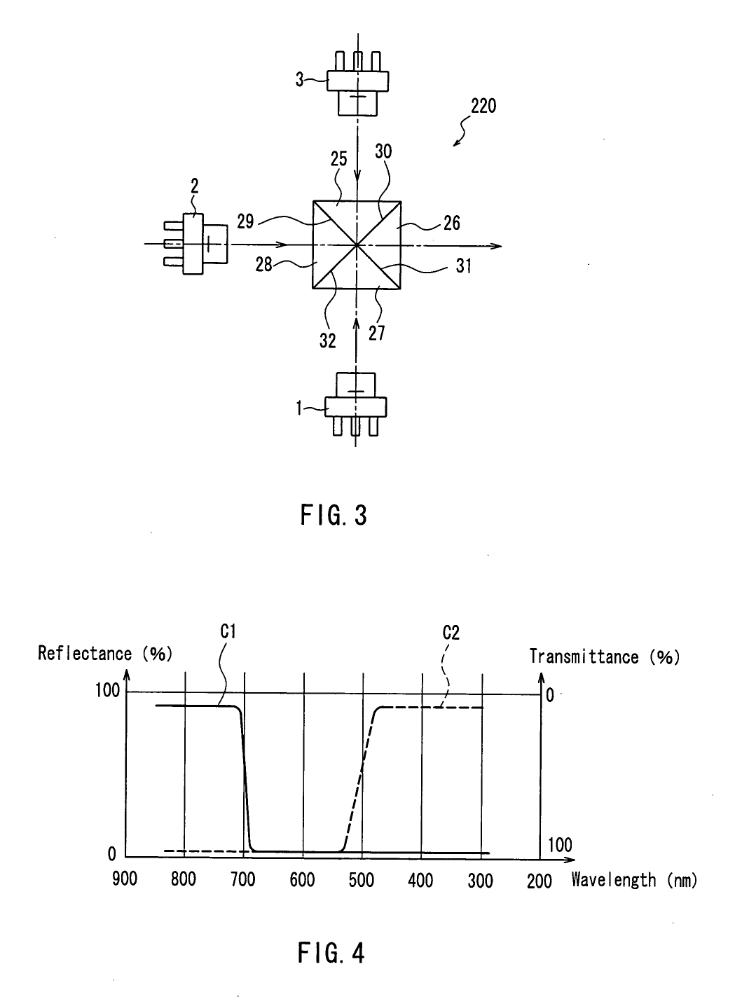

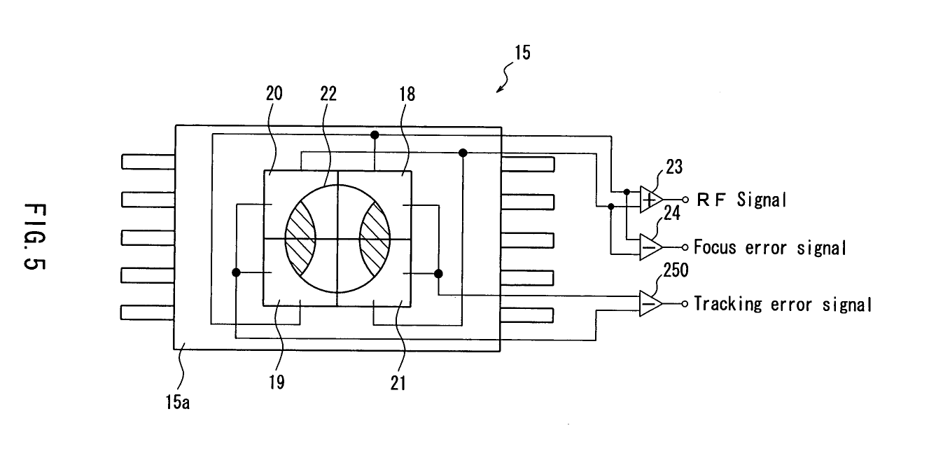

FIG. 1 schematically shows one example of an optical head 100 in Embodiment 1. FIG. 2 shows one example of a configuration of a wavelength separation prism 220. FIG. 3 schematically shows one example of a configuration of the wavelength separation prism 220 that serves as wavelength separation means of the optical head 100 in Embodiment 1 and light sources 1 to 3. FIG. 4 is a graph showing film characteristics of wavelength separation films in Embodiment 1. FIG. 5 schematically shows one example of a photodetector 15 provided in the optical head 100 in Embodiment 1.

Referring to FIGS. 1 to 5, reference numeral 1 denotes a semiconductor laser as a light source emitting a light beam of 750 nm to 850 nm, 2 denotes a semiconductor laser as a light source emitting a light beam of 600 nm to 700 nm and 3 denotes a semiconductor laser as a light source emitting a light beam of 400 nm to 500 nm.

Reference numeral 220 denotes a wavelength separation prism (also referred to as a beam splitter), and has a specific configuration such that, for example, four vertex angles of triangular prisms 25, 26, 27 and 28 made of glass, resin or transparent ceramic are opposed to one another while disposing wavelength separation films 29, 30, 31 and 32 between side faces of the adjacent triangular prisms 25 through 28, and a pressure is applied thereto in directions indicated by arrows (so that the side faces forming the vertex angles of the adjacent triangular prisms 25 through 28 are closer to each other), in order to bond optically two faces including the vertex angles so as to form substantially a hexahedron.

Herein, the wavelength separation film 30 may be formed either on the triangular prism 25 or 26. Similarly, the wavelength separation film 31 may be formed either on the triangular prism 26 or 27 and the wavelength separation film 32 may be formed either on the triangular prism 27 or 28. In addition, the wavelength separation film 29 may be formed either on the triangular prism 28 or 25.

In Embodiment 1, the wavelength separation films 29 and 31 have the same optical characteristics, and the wavelength separation films 30 and 32 have the same optical characteristics. That is to say, after applying the pressure thereto, the wavelength separation films 29 and 31 are on the same plane and the wavelength separation films 30 and 32 are on the same plane, and such wavelength separation films 29 and 31 (or the wavelength separation films 30 and 32) on the same plane are assigned the same optical characteristics.

As indicated by a curve C1 of FIG. 4, the wavelength separation films 30 and 32 have film characteristics such that a light beam having a wavelength longer than about 700 nm is reflected therefrom and a light beam having a wavelength not longer than about 700 nm is allowed to pass through. As indicated by a curve C2 of FIG. 4, the wavelength separation films 29 and 31 have film characteristics such that a light beam having a wavelength longer than about 500 nm is allowed to pass through and a light beam having a wavelength not longer than about 500 nm is reflected therefrom. At this time, the wavelength separation films 29 and 31 have a configuration such that a light beam having a wavelength of about 750 nm to 850 nm, which is so-called infrared light, and a light beam having a wavelength of about 600 nm to 700 nm, which is red light, are allowed to pass through.

Again, referring to FIG. 1, reference numeral 8 denotes a collimator lens, 10 denotes a polarized beam splitter having a polarization separation film 9, 11 denotes a λ/4 plate, 12 denotes an objective lens, 13 denotes an information recording medium, 14 denotes a detection lens that generates astigmatism and 15 denotes a photodetector that detects a servo signal and an RF signal.

The semiconductor lasers 1 through 3 are arranged so that their light-emission points are on a plane perpendicular to faces of the substantially hexahedral form beam splitter 220 on which the wavelength separation films 29 through 32 are provided (or side faces forming the vertex angles of the triangular prisms 25 through 28) and so that an optical axis of the semiconductor laser 1 and an optical axis of the semiconductor laser 2 form an angle of 90 degrees and the optical axis of the semiconductor laser 2 and an optical axis of the semiconductor laser 3 form an angle of 90 degrees.

In addition, in FIG. 1, reference numerals 16 and 17 denote a front focus and a back focus, respectively, due to the astigmatism generated by the detection lens 14. A light-receptive face 15a formed on the photodetector 15 is located substantially at a midpoint between the front focus 16 and the back focus 17 that are arranged along a Z direction indicated in FIG. 1.

Now referring to FIG. 5, reference numerals 18, 19, 20 and 21 denote light-receptive regions arranged on the light-receptive face 15a of the photodetector 15, and 22 denotes a light spot formed on the light-receptive regions. The amounts of all of the light received at the light-receptive regions 18, 19, 20 and 21 are added by an adder 23 so as to detect an RF signal. In addition, a differential signal between a signal obtained by adding the amounts of light received at the light-receptive regions 18 and 19 and a signal obtained by adding the amounts of light received at the light-receptive regions 20 and 21 is produced by a subtracter 24, which allows the detection of a focus error signal by so-called an astigmatism method. Furthermore, a differential signal between a signal obtained by adding the amounts of light received at the light receptive regions 19 and 20 and a signal obtained by adding the amounts of light received at the light receptive regions 18 and 21 is produced by a subtracter 250, which allows the detection of a tracking error signal by so-called a push-pull method.

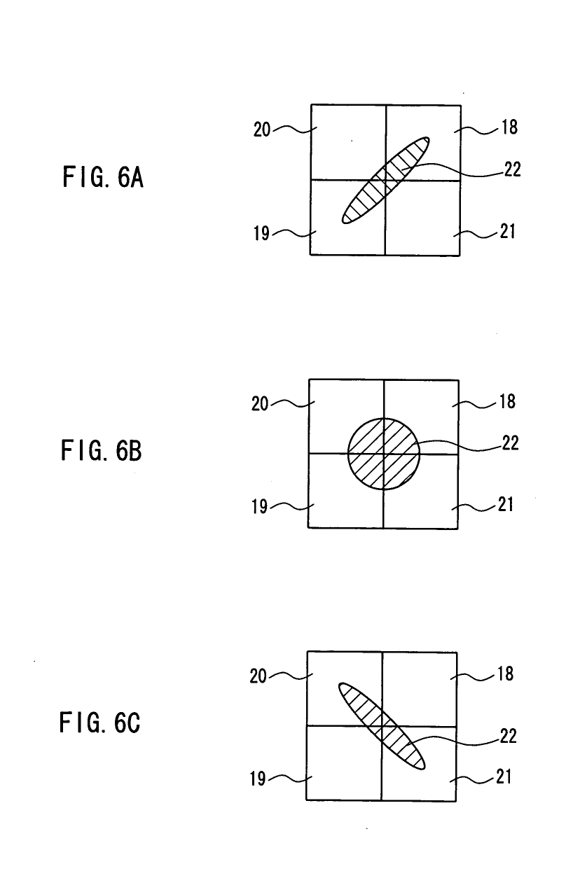

FIGS. 6A to 6C each shows a shape of the light spot formed through the detection lens 14 on the light-receptive face 15a of the photodetector 15. FIG. 6A shows the light spot 22 in a state where the information recording medium 13 and the objective lens 12 are close to each other, and FIG. 6C shows the light spot 22 formed in a state where the information recording medium 13 and the objective lens 12 are away from each other. FIG. 6B shows the light spot 22 in substantially a middle state between FIG. 6A and FIG. 6C that is in a state of just focus.

The following describes an operation of the thus configured optical head 100 according to Embodiment 1.

A light beam (infrared light) of 750 nm to 850 nm that is emitted from the semiconductor laser 1 is reflected from the wavelength separation films 30 and 32 while passing through the wavelength separation film 31, and a divergent light beam emitted from the wavelength separation prism 220 enters into the collimator lens 8 to be used for reproducing from CDs or recording on CD-Rs. At this time, the characteristics of the wavelength separation film 29 do not affect the operation using the semiconductor laser 1.

A light beam (infrared light) of 600 nm to 700 nm that is emitted from the semiconductor laser 2 passes through the wavelength separation films 30 and 32 while passing through the wavelength separation films 29 and 31, and a divergent light beam emitted from the wavelength separation prism 220 enters into the collimator lens 8 to be used for reproducing from DVD-ROMs and recording on DVD-RAMs, DVD-Rs, DVD+Rs, DVD-RWs, DVD+RWs and the like.

A light beam (blue light) of 400 nm to 500 nm that is emitted from the semiconductor laser 3 is reflected from the wavelength separation films 29 and 31 while passing through the wavelength separation film 30, and a divergent light beam emitted from the wavelength separation prism 220 enters into the collimator lens 8 to be used for recording/reproducing with respect to Blu-ray Disks, for example. At this time, the characteristics of the wavelength separation film 30 do not affect the operation using the semiconductor laser 3.

Therefore, as shown in FIGS. 3 and 4, the wavelength separation films 29, 30, 31 and 32 may have two types of film characteristics for the wavelength separation films 30 and 32 and for the wavelength separation films 29 and 31, which are on the same diagonal lines, respectively.

A divergent light beam that is emitted from any one of the semiconductor lasers 1 to 3 enters into the collimator lens 8 to be converted into a parallel light beam, and passes through the polarized beam splitter 10 having the polarization separation film 9 to enter into the λ/4 plate 11. Polarizing directions of the semiconductor lasers 1 to 3 are set at directions parallel to the sheet of FIG. 1 (directions indicated by arrows in this drawing), so as to allow a divergent light beam to pass through the polarization separation film 9. The parallel light beam as linear polarized light that is incident on the λ/4 plate 11 is changed to circular polarized light, which enters into the objective lens 12 so as to form a light spot with a diameter of 1 μm or less on the information recording medium 13. Then, a light beam reflected from the information recording medium 13 travels along a reversed path so as to enter into the λ/4 plate 11.

When entering into the λ/4 plate 11, the light beam is circular polarized light. However, after passing through the λ/4 plate 11, it becomes linear polarized light that is polarized along a direction perpendicular to the sheet of FIG. 1, which is then reflected from the polarization separation film 9 to enter into the detection lens 14. A first surface of the detection lens 14 is a convex lens and a second surface thereof is a so-called cylindrical lens whose cylindrical axis is set at about 45 degrees relative to a plane parallel to the sheet of FIG. 1. Therefore, astigmatism is generated between a direction of the cylindrical axis and a direction perpendicular to the cylindrical axis (See FIG. 3). The light beam passing through the detection lens 14 enters into the photodetector 15.

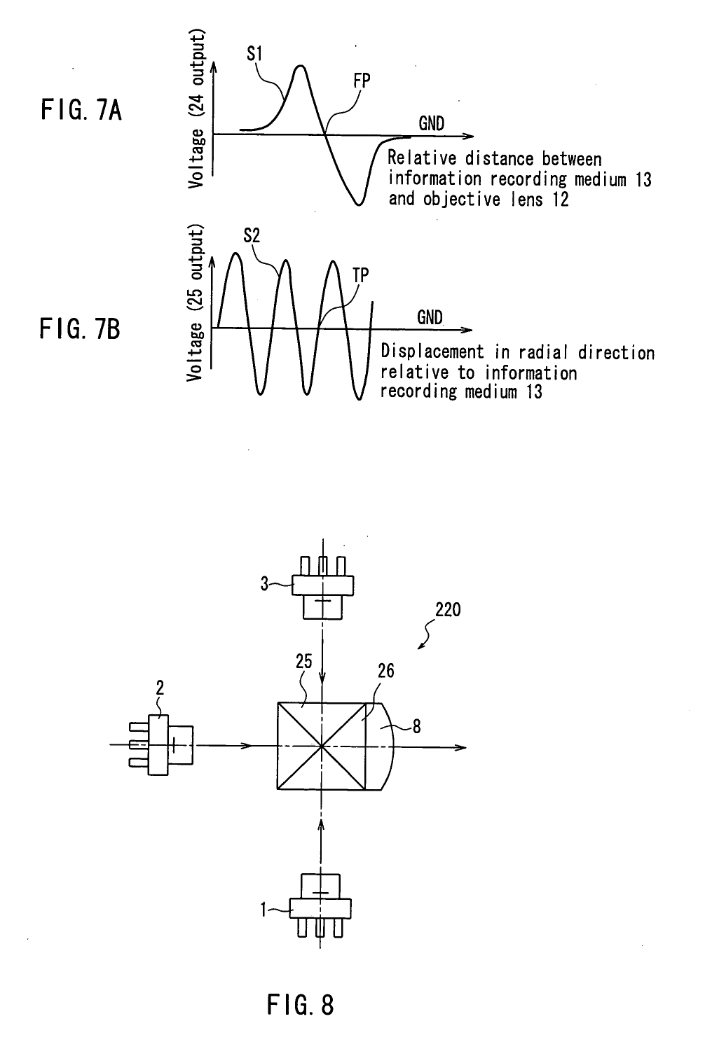

The focus servo of the objective lens 12 would be converged to an intersection point FP of a focus error signal S1 (a so-called S-shaped signal) output from the subtracter 24 and the GND as shown in FIG. 7A. Similarly, the tracking error signal S2 of the objective lens 12 would be converged to an intersection point TP of the tracking error signal S2 output from the subtracter 25 and the GND as shown in FIG. 7B. Furthermore, an RF signal can be obtained by detecting a change in the amount of light reflected from the information recording medium 13. Then, the calculation concerning the size would be performed based on an output signal from the adder 23.

In this way, according to Embodiment 1, vertex angles of the four triangular prisms 25, 26, 27 and 28 are opposed one another, where two faces including the vertex angle are bonded to each other with a UV cure adhesive and the like so as to form the substantially hexahedral wavelength separation prism 220, and, among the four wavelength separation films 29, 30, 31 and 32 that intersect one another on diagonal lines of the wavelength separation prism 220, the wavelength separation films 29 and 31 and the wavelength separation films 30 and 32 respectively are made to have the same film characteristics, whereby the beam splitter 220 having the wavelength separation films 29, 30, 31 and 32 can be configured. As a result, the beam splitter 220 having a wavelength separation function can be realized so as to be compatible with all of the three types of semiconductor lasers 1, 2 and 3 that have wavelengths different from one another, thus making it possible to make the wavelength separation function smaller and thinner, which also leads to a smaller and thinner optical head and disk recording/reproducing apparatus.

Note here that, although Embodiment 1 has a so-called infinite optical configuration using the collimator lens 8, it may have a finite optical configuration without the collimator lens 8.

In addition, the collimator lens 8 may be arranged between the beam splitter 220 and each of the semiconductor lasers 1 through 3.

In addition, as shown in FIG. 8, the collimator lens 8 may be attached to the emission surface of the beam splitter 220, or the collimator lens 8 may be molded integrally with the triangular prism 26 using a resin.

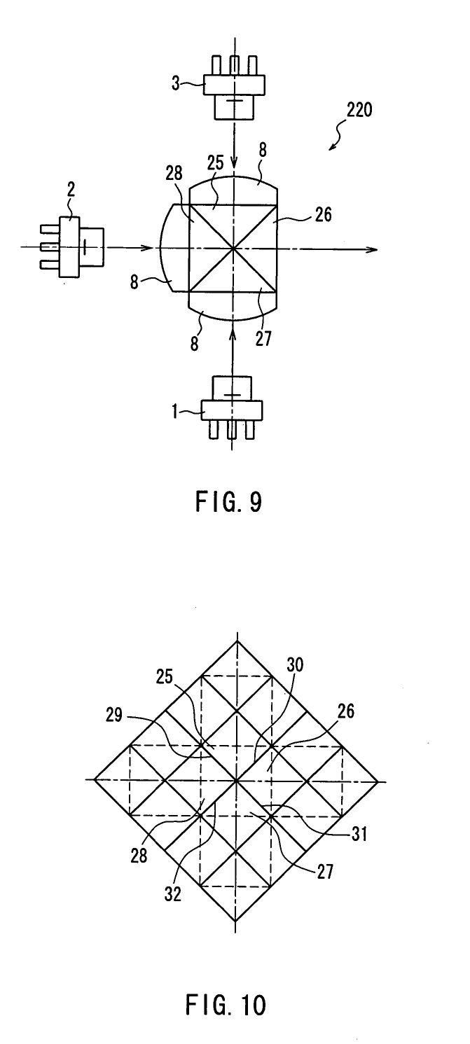

Furthermore, as shown in FIG. 9, the collimator lenses 8 may be disposed on the incident surface side of the beam splitter 220 so as to be integrally configured or molded with the triangular prisms 25, 27 and 28. By integrally configuring or molding of the collimator lens 8 with the triangular prisms 25, 26, 27 and 28, substantial miniaturization and low cost can be realized.

In addition, in Embodiment 1, there are two types of characteristics of wavelength separation films including for the wavelength separation films 29 and 31 and for the wavelength separation films 30 and 32. However, the wavelength separation film 29 may have any characteristics concerning a light beam (infrared light) of 750 nm to 850 nm, and therefore the wavelength separation films 29 and 31 may have different film characteristics from each other. The wavelength separation film 32 may have any characteristics concerning a light beam (blue light) of 400 nm to 500 nm, and therefore the wavelength separation films 30 and 32 may have different film characteristics from each other. Therefore, the types of the wavelength separation films 29, 30, 31 and 32 may be any one of two to four types.

In addition, in Embodiment 1, vertex angles of the four triangular prisms 25, 26, 27 and 28 are opposed and attached to one another. However, the present invention is not limited to this. As shown in FIG. 10, quadratic prisms may be attached to one another and be cut along broken lines.

In Embodiment 1, the wavelengths of the semiconductor lasers 1, 2 and 3 are three types including 750 nm to 850 nm (infrared light), 600 nm to 700 nm (infrared light) and 400 nm to 500 nm (blue light), respectively. However, among four types including 300 nm to 400 nm (green light), any three types of semiconductor lasers may be used, and characteristics of the wavelength separation films 29 to 32 of the wavelength separation prism 220 may be changed in accordance with the wavelengths of these semiconductor lasers.

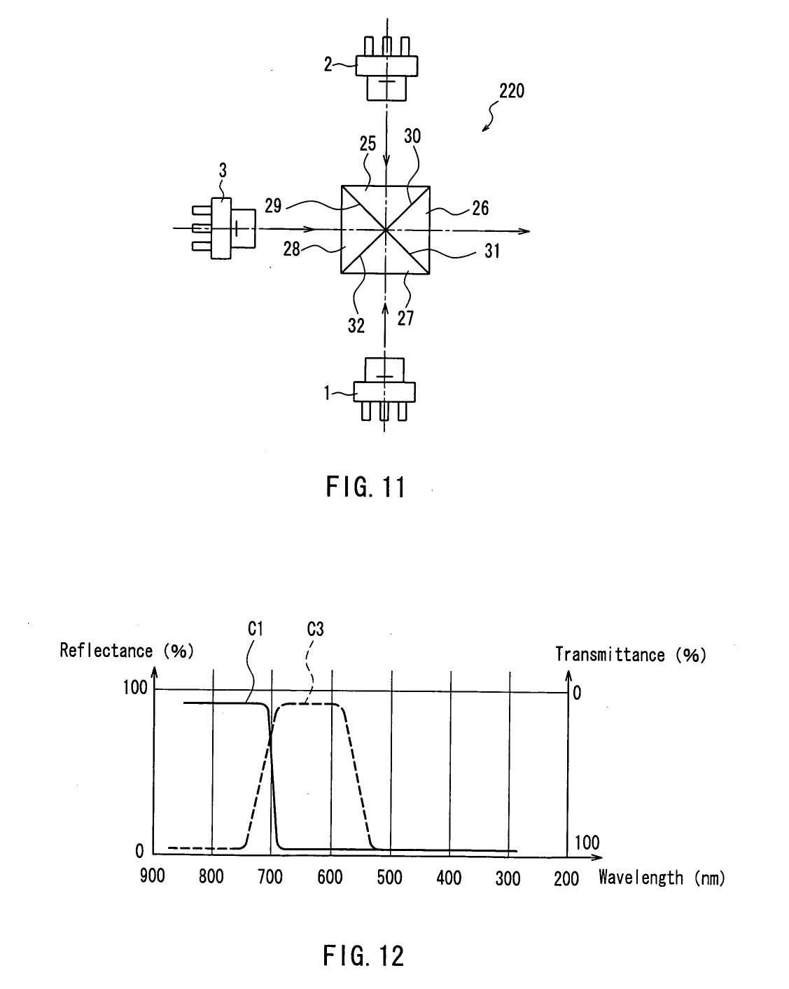

Needless to say, as shown in FIG. 11, the respective positions of the semiconductor lasers 1, 2 and 3 may be changed so that the semiconductor lasers 1 and 3 are next to each other, the semiconductor lasers 3 and 2 are next to each other and the semiconductor lasers 1 and 2 are opposed to each other, and the characteristics C1 of the wavelength separation films 30 and 32 and the characteristics C3 of the wavelength separation films 29 and 31 may be set as shown in FIG. 12.

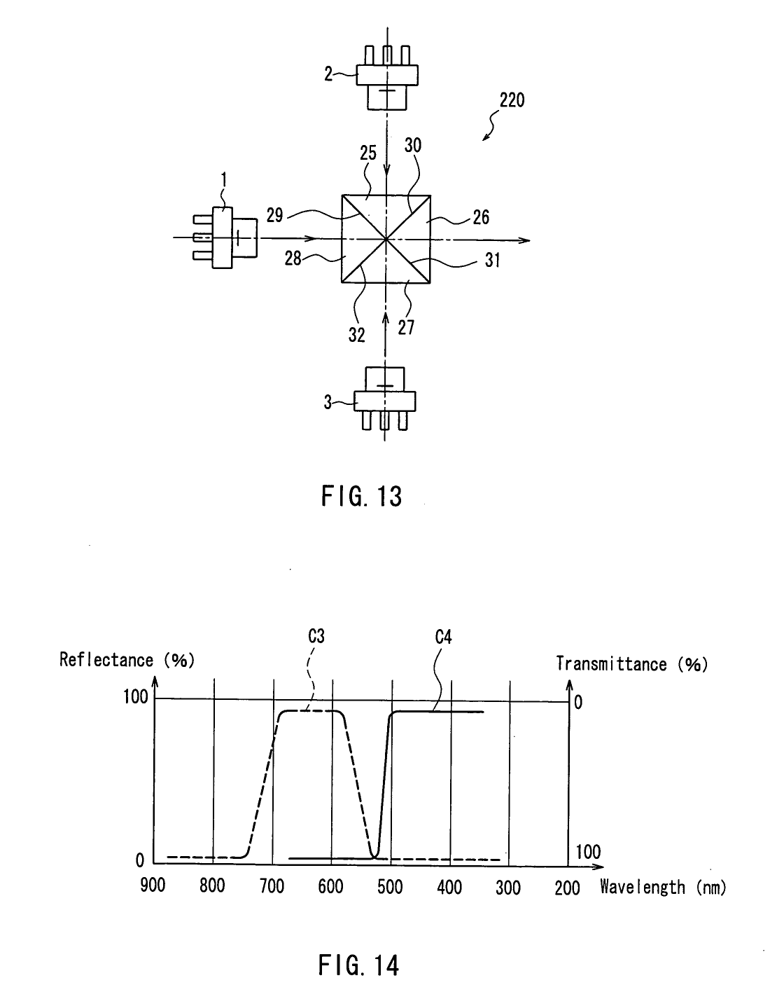

Similarly, as shown in FIG. 13, the respective positions of the semiconductor lasers 1, 2 and 3 may be changed so that the semiconductor lasers 1 and 3 are next to each other, the semiconductor lasers 1 and 2 are next to each other and the semiconductor lasers 2 and 3 are opposed to each other, and the characteristics C3 of the wavelength separation films 29 and 31 and the characteristics C4 of the wavelength separation films 30 and 32 may be set as shown in FIG. 14. In this way, the semiconductor lasers may be disposed at any other position.

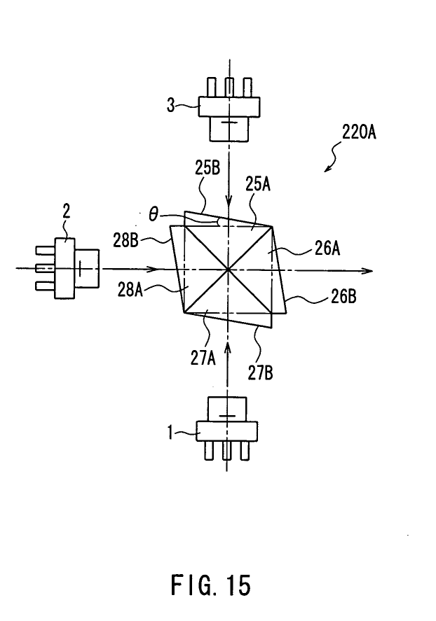

FIG. 15 explains a configuration of a modification example of the wavelength separation prism. The prism may be a quadratic prism instead of a triangular prism. A wavelength separation prism 220A includes prisms 25A, 26A, 27A and 28A each having substantially a quadratic prism shape. The prism 25A that is arranged so as to be opposed to the semiconductor laser 3 has an incident surface 25B that is tilted by an angle θ relative to a direction perpendicular to an optical axis of the semiconductor laser 3 so that astigmatism can be cancelled out. The prism 27A that is arranged so as to be opposed to the semiconductor laser 1 has an incident surface 27B that is tilted by an angle θ relative to a direction perpendicular to an optical axis of the semiconductor laser 1 so that astigmatism can be cancelled out. The prism 28A that is arranged so as to be opposed to the semiconductor laser 2 has an incident surface 28B that is tilted by an angle θ relative to a direction perpendicular to an optical axis of the semiconductor laser 2 so that astigmatism can be cancelled out. The prism 26A has an emission surface 26B that is tilted by an angle θ relative to a direction perpendicular to an optical axis of the semiconductor laser 2 so that astigmatism can be cancelled out. In this way, a wavelength separation prism configured with quadratic prisms allows astigmatism to be cancelled out.

Embodiment 2

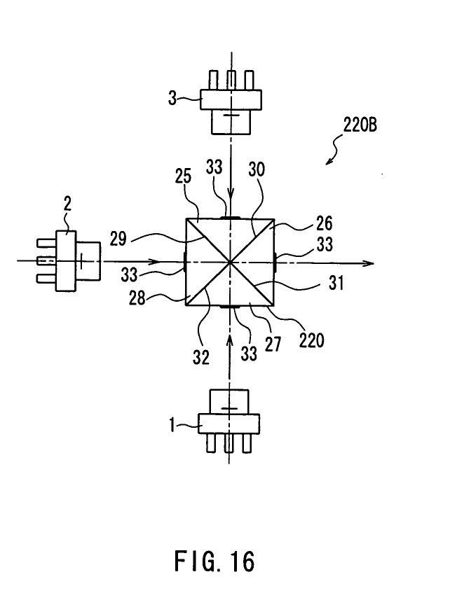

The following describes Embodiment 2, with reference to FIG. 16. FIG. 16 explains one example of a configuration of an optical head according to Embodiment 2. The optical head according to Embodiment 2 includes a wavelength separation prism 220B. Differences from Embodiment 1 reside in that each of prisms 25, 26, 27 and 28 provided in the wavelength separation prism 220B is provided with an optical filter 33 for carrying out a light shield or reducing a transmittance at substantially a center of an optical axis. Embodiment 2 illustrates the configuration in which the optical filter 33 is provided on each of the emission surface side and the incident surface side. However, the present invention is not limited to this. The optical filter 33 may be disposed either on the emission surface side only or on an arbitrary incident surface side. The optical filter 33 may have either a circular shape or an oval shape.

This configuration can avoid the generation of wave aberration resulting from the discontinuity of the wavelength separation films 29, 30, 31 and 32 at the tips of the triangular prisms of the beam splitter 220B configured by attaching the triangular prisms 25, 26, 27 and 28, and also so-called a super-resolution effect allows a decrease in light spot diameter on an information recording medium 13. Therefore, a further higher performance of the optical head and a further higher performance of a disk recording/reproducing apparatus can be realized.

Embodiment 3

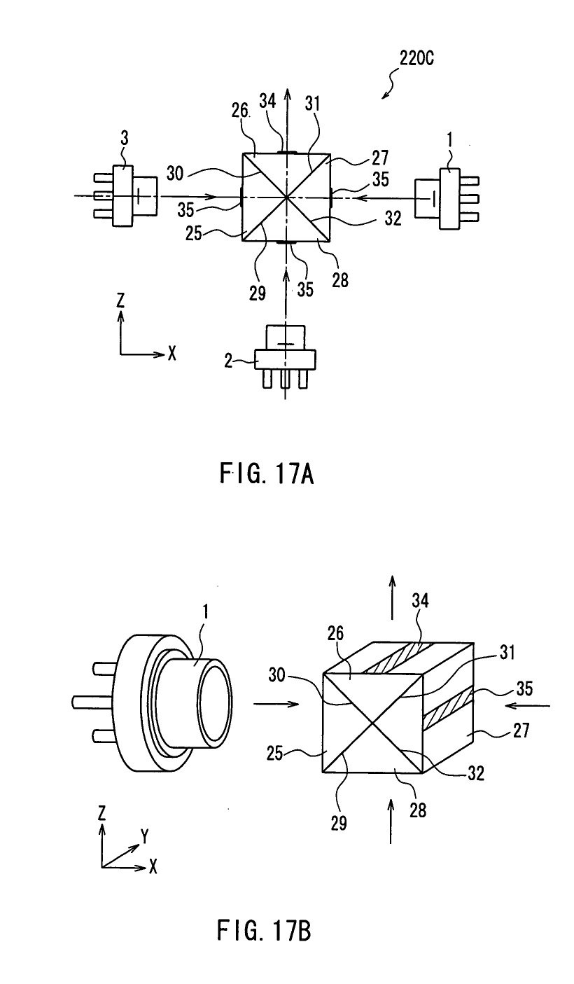

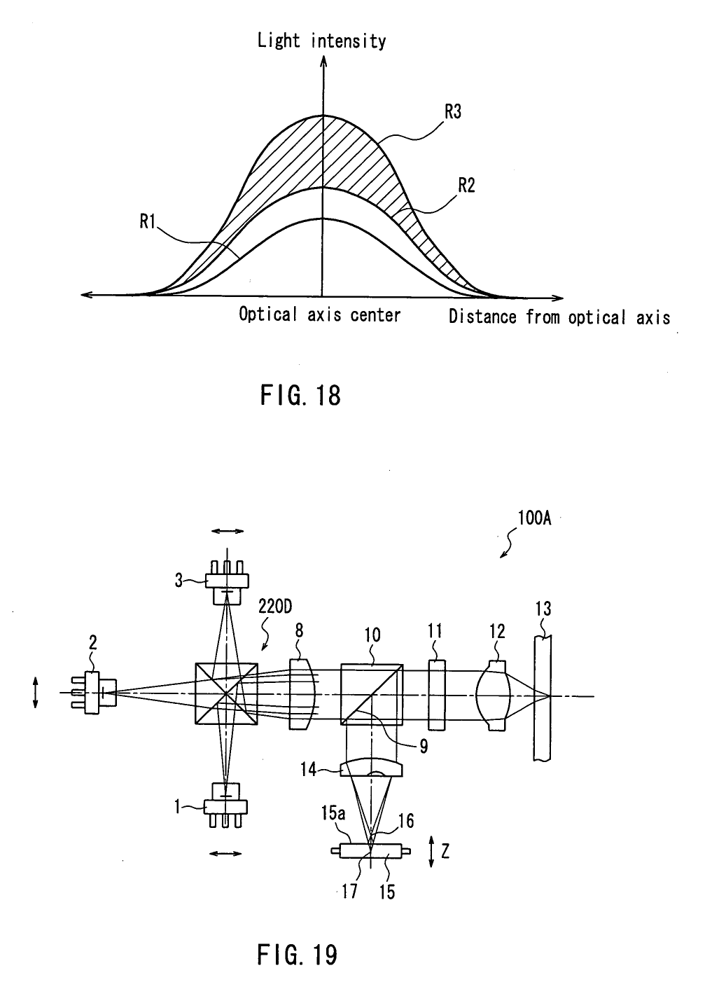

The following describes Embodiment 3, with reference to FIGS. 17A, 17B and 18. Note here that, in FIG. 17B, semiconductor lasers 2 and 3 are not illustrated.

An optical head according to Embodiment 3 includes a wavelength separation prism 220C. Differences from Embodiment 1 and Embodiment 2 reside in that a strip-shaped reflection film 34 (or a filter for reducing a transmittance) is provided at substantially a center of an emission-side surface of a triangular prism 26 provided in the wavelength separation prism 220C, and strip-shaped reflection films 35 (or filters for reducing a transmittance) are provided at substantially centers of incident-side faces of triangular prisms 25, 27 and 28. At this time, the reflection films 34 and 35 are formed in the strip shape so as to be parallel to sides having vertex angles of the triangular prisms 25 to 28.

FIG. 18 is a graph showing a relationship between a distance from a center of an optical axis and a light intensity in Embodiment 3. A curve R1 indicates the light intensity on a side of a large angle of divergence, and a curve R3 indicates the light intensity on a side of a small angle of divergence. A curve R2 indicates the light intensity when a RIM intensity is corrected by the reflection film 34.

As shown in FIG. 18, by decreasing the amount of light, indicated by the curve R3, in the vicinity of the center on the side of a small angle of divergence in the semiconductor lasers 1, 2 and 3 as shown in the curve R2, the RIM intensity (a difference of the light intensity at an effective diameter portion of an objective lens relative to the light intensity at a center of the objective lens) of a light beam incident on an objective lens 12 can be reduced. Therefore, a light spot on an information recording medium 13 can be reduced, and an optical head allowing a further higher density recording can be realized. At this time, the reflection film 34 may be provided on the emission side or the reflection film 35 may be provided on each of the incident sides.

In addition, this configuration can suppress the generation of wave aberration resulting from the discontinuity of the wavelength separation films 29, 30, 31 and 32 at the tips of the triangular prisms 25, 26, 27 and 28, and can realize a favorable light spot with a reduced aberration, and therefore an optical head that allows a further higher density recording can be realized.

Embodiment 4

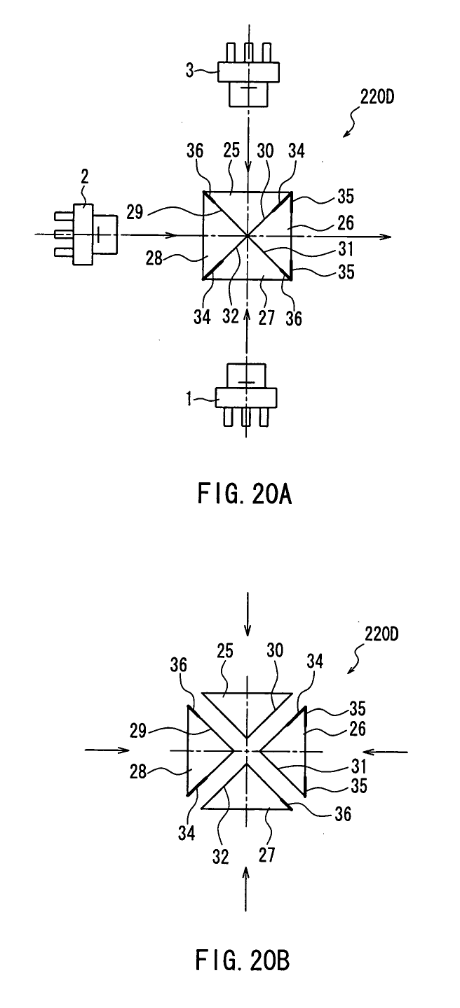

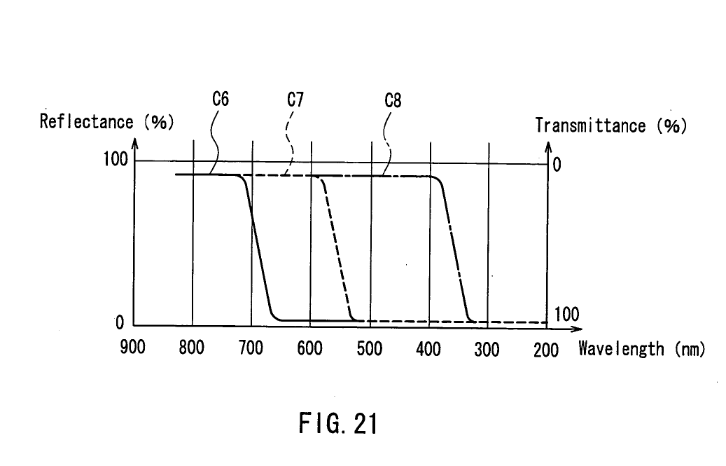

The following describes Embodiment 4, with reference to FIGS. 19, 20A, 20B and 21. An optical head 100A according to Embodiment 4 includes a wavelength separation prism 220D. Differences from Embodiments 1, 2 and 3 reside in that reflection films 34, 35 and 36 are provided in the wavelength separation prism 220D so as to correspond to the wavelengths of the semiconductor lasers 1, 2 and 3, respectively, and the restriction on an aperture is applied for each of the semiconductor lasers by the wavelength separation prism 220D. The reflection film 34 is formed so as to cover a portion of an outer side of wavelength separation films 30 and 32, and has film characteristics C6 shown in FIG. 21. The reflection film 36 is formed so as to cover a portion of an outer side of wavelength separation films 29 and 31, and has film characteristics C8 shown in FIG. 21. The reflection film 35 is formed so as to cover a portion of an outer side of an emission surface of a triangular prism 26, and has film characteristics C7 shown in FIG. 21.

With this configuration, the diameter of a light beam incident on an objective lens 12 can be restricted by the wavelength separation prism 220D. As a result, there is no need to carry out the restriction on an aperture depending on the wavelength of the semiconductor laser by the objective lens, and an unnecessary light beam does not arrive at the collimator lens 8 side. Therefore, stray light can be reduced substantially, and a further higher precision optical head and disk recording/reproducing apparatus can be realized.

Embodiment 5

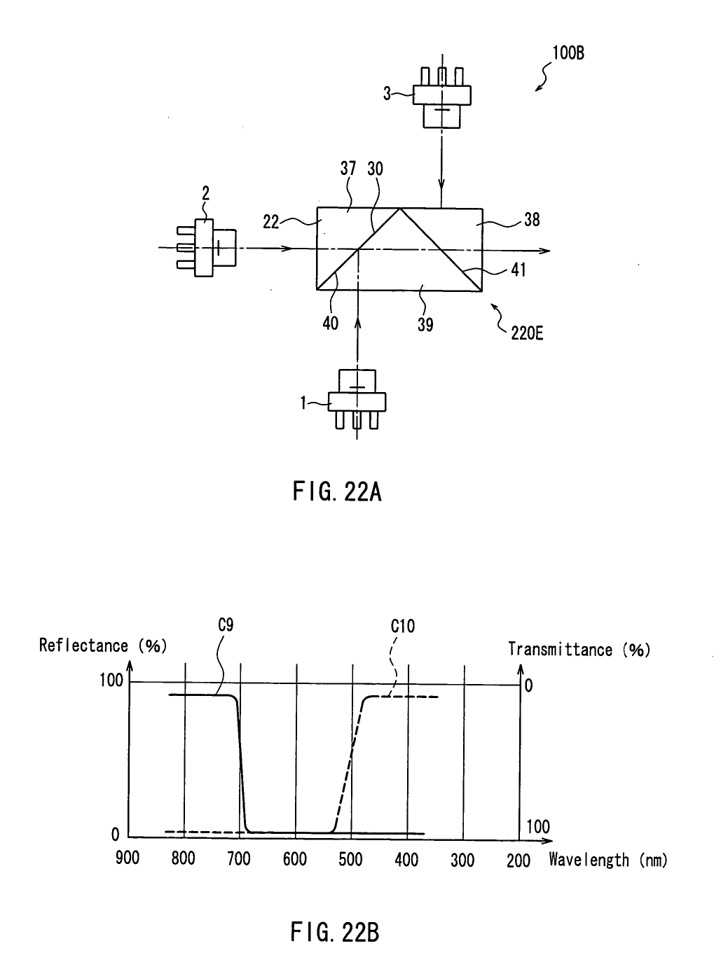

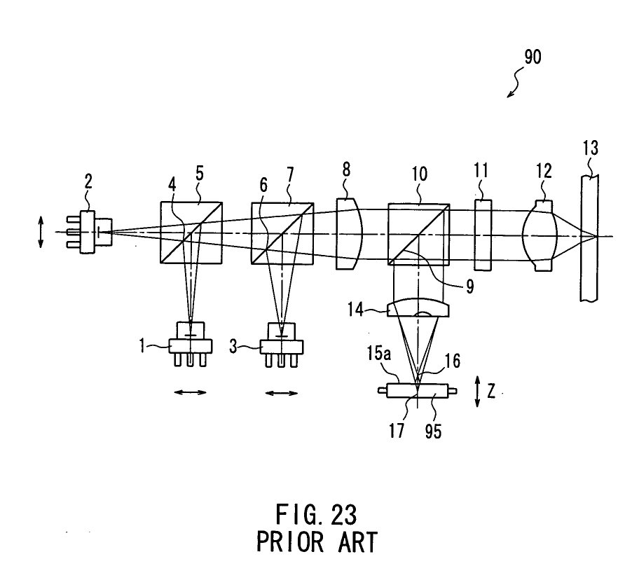

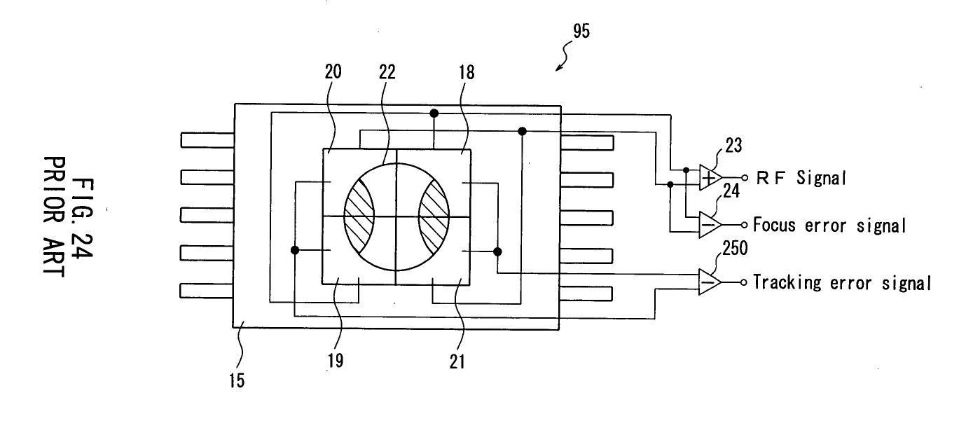

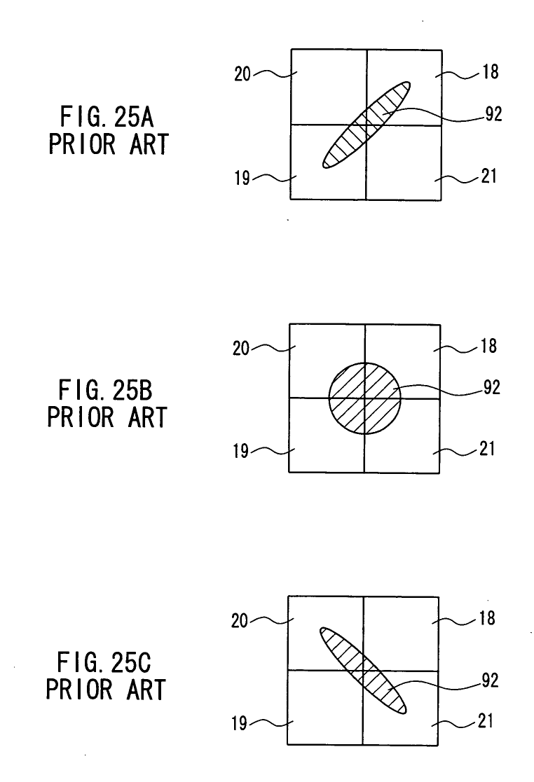

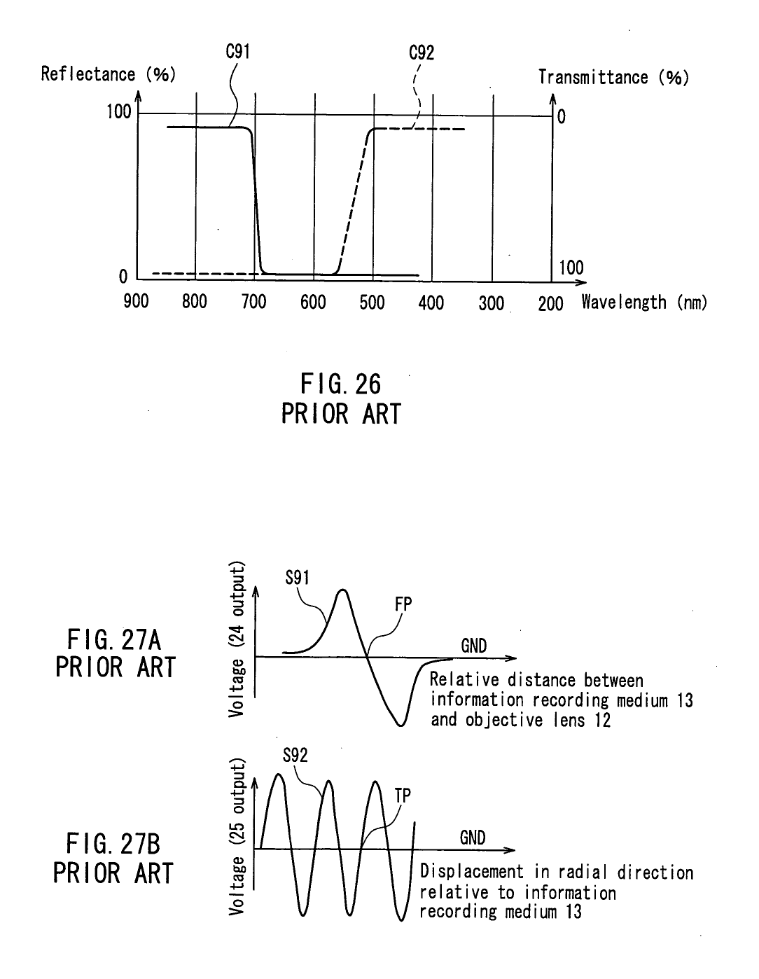

The following describes Embodiment 5, with reference to FIG. 22A and FIG. 22B. An optical head 100B according to Embodiment 5 includes a wavelength separation prism 220E. Differences from Embodiments 1, 2, 3 and 4 reside in that the wavelength separation prism 220E is configured with triangular prisms 37, 38 and 39 and wavelength separation films 40 and 41. FIG. 22A shows a configuration of the optical head 100B, and FIG. 22B is a graph showing film characteristics C9 of the wavelength separation film 40 and film characteristics C10 of the wavelength separation film 41. With this configuration, there is no discontinuity at a center portion of the wavelength separation film as in Embodiments 1, 2, 3 and 4, and therefore an optical head of small size and with an excellent aberration property can be realized and also a high performance disk recording/reproducing apparatus can be realized.

Note here that the above Embodiments 1 to 5 describe as one example that the light sources and the photoreceptor are separately provided. However, there is no need to limit the present invention to such an example, and light sources with the respective wavelengths and the corresponding photoreceptors, which are integrally provided, may be used.

The optical heads according to the present embodiments have three light sources with different wavelengths and a beam splitter that allows light beams from the light sources to pass through or reflects the light beams. The beam splitter is substantially a hexahedron by optically bonding four triangular prisms so that, when vertex angles of the four triangular prisms are opposed to one another, an optical film having desired optical characteristics can be arranged between four side surfaces of the adjacent triangular prisms, and light emission points of the three light sources are located in a plane substantially perpendicular to the side faces of the four triangular prisms, which are the faces with the optical films provided thereon. As a result, the beam splitter enables the wavelength separation of the three light sources with different wavelengths. Therefore, a configuration for selecting a wavelength can be miniaturized as compared with the conventional one, and thus an optical head and a disk recording/reproducing apparatus can be made smaller and thinner.

Additionally, the inclusion of one beam splitter allows substantially a reduction in the number of assembly steps and an enhancement of assembly accuracy and environmental stability, which can realize an optical head and a disk recording/reproducing apparatus with high precision, high reliability and low cost.

In addition, when the vertex angles of the four triangular prisms are opposed and bonded optically to one another so as to form the beam splitter in substantially a hexahedron form, two optical films on the same plane among the four optical films formed on the four side faces of the triangular prisms are made to have the same optical characteristics. Therefore, the beam splitter allows the wavelength separation of the three light sources with different wavelengths. Thus, a configuration for selecting a wavelength can be miniaturized as compared with the conventional one, and therefore an optical head and a disk recording/reproducing apparatus can be made smaller and thinner. Additionally, the inclusion of one beam splitter allows a substantial reduction in the number of assembly steps and an enhancement of assembly accuracy and environmental stability, which can realize an optical head and a disk recording/reproducing apparatus with high precision, high reliability and low cost.

In addition, the light sources may emit three different types of wavelengths among four types of 750 nm to 850 nm, 600 nm to 700 nm, 400 nm to 500 nm and 300 nm to 400 nm, thus enabling the configuration of an optical head for the corresponding three wavelengths.

The light sources are arranged to have about 90 degrees or 180 degrees relative to one another in a plane perpendicular to the surfaces on which the optical films are provided in the beam splitter in substantially a hexahedral form, thus enabling the configuration of an optical head for the corresponding three wavelengths.

In addition, by configuring the optical films provided in the beam splitter so as to have characteristics of a reflectance or a transmittance varied in accordance with the wavelength of light passing through the optical films and so as to allow light with a predetermined wavelength to pass through or reflect such a wavelength, the wavelength separation for the three light sources with different wavelengths can be achieved.

In addition, in the beam splitter in substantially a hexahedral form, when the vertex angles of the four triangular prisms are opposed to one another, two to four types of optical characteristics may be given to the four optical films respectively provided between the four side faces of the adjacent triangular prisms, thus enabling the wavelength separation for the three light sources with different wavelengths.

In addition, in the beam splitter in substantially a hexahedral form, when the vertex angles of the four triangular prisms are opposed to one another, at least one of the four optical films provided between the four side faces of the adjacent triangular prisms may have an optical filter function, and light shielding is carried out or a transmittance is reduced at substantially a center portion of a light beam in a circular shape or an oval shape, thus avoiding the generation of wave aberration resulting from the discontinuity of the optical films at the tips of the triangular prisms, and reducing a light spot diameter focused on an information recording medium because of so-called a super-resolution effect.

In addition, in the beam splitter in substantially a hexahedral form, when the vertex angles of the four triangular prisms are opposed to one another, at least one of the four optical films provided between the four side faces of the adjacent triangular prisms may have an optical filter function, and the optical filter for carrying out light-shielding or reducing a transmittance may be shaped in a strip shape so as to be parallel to sides having vertex angles of the triangular prisms, thus avoiding the generation of wave aberration resulting from the discontinuity of the optical films at the tips of the triangular prisms, and reducing a light spot diameter focused on an information recording medium because of a so-called super-resolution effect.

In addition, in the beam splitter in substantially a hexahedral form, the optical films may have a wavelength separation function so as to allow only a predetermined wavelength to pass through or reflect such a wavelength only, and may have a function for restricting an aperture by which a transmissive or reflective region is varied in accordance with the predetermined wavelength, thus enabling the restriction of a diameter of a light beam that is emitted from the beam splitter and enters into an objective lens by the optical films. Therefore, without the use of an optical filter for restricting an aperture in accordance with a wavelength of a semiconductor laser, stray light can be reduced substantially, and a further higher precision optical head can be realized.

In addition, in the beam splitter in substantially a hexahedral form, the four triangular prisms may be made of glass, resin or transparent ceramic, thus increasing a transmittance of incident light while enabling the wavelength separation for the three light sources with different wavelengths.

The optical head according to the present embodiment has three light sources with different wavelengths and a beam splitter that allows light beams from the light sources to pass through or reflects the light beams. The beam splitter has three triangular prisms and is formed as substantially a hexahedron by disposing optical films having different optical characteristics between two faces including a vertex angle of the substantially triangular prism and side faces of the other two substantially triangular prisms and by optically bonding the same, and the three light sources are arranged so that light emission points of the three light sources are located in a plane substantially perpendicular to the optical films. As a result, the beam splitter enables the wavelength separation of the three light sources with different wavelengths. Therefore, a configuration for selecting a wavelength can be miniaturized as compared with the conventional one, and thus an optical head and a disk recording/reproducing apparatus can be made smaller and thinner. Additionally, the inclusion of one beam splitter allows substantially a reduction in the number of assembly steps and an enhancement of assembly accuracy and environmental stability, which can realize an optical head and a disk recording/reproducing apparatus with high precision, high reliability and low cost.

The present invention is applicable to an optical head that is used for a disk recording/reproducing apparatus that records and reproduces information optically by projecting a light spot on a disk-shaped recording medium.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An optical head, comprising:
a first light source having a first wavelength and a first optical axis;
a second light source having a second wavelength different from the first wavelength and a second optical axis intersecting with the first optical axis;
a third light source having a third wavelength different from the first wavelength and the second wavelength and a third optical axis that is substantially parallel to the first optical axis; and
a beam splitter provided for allowing light beams from the first light source, the second light source and the third light source to pass through or reflecting these light beams, the beam splitter being surrounded with the first light source, the second light source and the third light source,
wherein the beam splitter comprises:
a first prism that is provided so that the light beam from the first light source enters therein;
a second prism that is provided so that the light beam from the second light source enters therein;
a third prism that is provided so that the light beam from the third light source enters therein;
a fourth prism that is provided between the first prism and the third prism so as to be opposed to the second prism;
a first optical film that is formed between the first prism and the second prism;
a second optical film that is formed between the second prism and the third prism;
a third optical film that is formed between the third prism and the fourth prism; and
a fourth optical film that is formed between the fourth prism and the first prism,
wherein the first to the fourth optical films have desired optical characteristics for allowing the light beam from the first light source that enters into the first prism and has the first wavelength, the light beam from the second light source that enters into the second prism and has the second wavelength and the light beam from the third light source that enters into the third prism and has the third wavelength to pass through or for reflecting these light beams.

2. The optical head according to claim 1,
wherein the first to the fourth prisms have a substantially triangular prism form, and
the beam splitter has substantially a hexahedral form that is formed with a bottom face, a top face and one of the side faces of each of the first to the fourth prisms.

3. The optical head according to claim 1,
wherein the first optical film and the third optical film are formed on the same plane and have the same optical characteristics, and
the second optical film and the fourth optical film are formed on the same plane and have the same optical characteristics.

4. The optical head according to claim 1,
wherein the first wavelength, the second wavelength and the third wavelength respectively are three different wavelengths selected from four types including 750 nm to 850 nm, 600 nm to 700 nm, 400 nm to 500 nm and 300 nm to 400 nm.

5. The optical head according to claim 1,
wherein the first optical axis and the second optical axis intersect at substantially right angles, and
the first optical axis and the third optical axis form an angle of substantially 180 degrees.

6. The optical head according to claim 1, wherein a reflectance or a transmittance of each of the first to the fourth optical films is changed in accordance with a wavelength of an incident light beam.

7. The optical head according to claim 1,
wherein the first optical film and the third optical film have optical characteristics such that a light beam having a wavelength not shorter than a first threshold value is allowed to pass through and a light beam having a wavelength shorter than the first threshold value is reflected therefrom, and
the second optical film and the fourth optical film have optical characteristics such that a light beam having a wavelength not shorter than a second threshold value that is higher than the first threshold value is reflected therefrom and a light beam having a wavelength shorter than the second threshold value is allowed to pass through.

8. The optical head according to claim 1, wherein a reflection film for reducing an amount of light at substantially a center portion of a light beam is formed on at least one of the first to the fourth prisms.

9. The optical head according to claim 8, wherein the reflection film has any one of a strip shape, a circular shape and an oval shape.

10. The optical head according to claim 1, wherein a light beam diameter restriction film that restricts a diameter of a light beam emitted from the beam splitter is formed on the beam splitter.

11. The optical head according to claim 1, wherein the first to the fourth prisms are made of at least one selected from the group consisting of glass, resin, and transparent ceramic.

12. The optical head according to claim 1, further comprising a collimator lens that is provided for converting the light beams emitted from the first to the third light sources into parallel beams,
wherein the collimator lens is provided so as to be attached to the fourth prism.

13. The optical head according to claim 1, further comprising collimator lenses that are provided for converting the light beams emitted from the first to the third light sources into parallel beams,
wherein the collimator lenses are disposed between the first light source and the first prism, between the second light source and the second prism and between the third light source and the third prism.

14. The optical head according to claim 1,
wherein each of the first to the third prisms has an incident surface that is formed so as to cancel astigmatisms possessed by the light sources, and
the fourth prism has an emission surface that is formed so as to cancel the astigmatisms possessed by the light sources.

15. An optical head, comprising:
a first light source having a first wavelength and a first optical axis;
a second light source having a second wavelength different from the first wavelength and a second optical axis intersecting with the first optical axis;
a third light source having a third wavelength different from the first wavelength and the second wavelength and a third optical axis that is substantially parallel to the first optical axis; and
a beam splitter provided for allowing light beams from the first light source, the second light source and the third light source to pass through or reflecting these light beams, the beam splitter being surrounded with the first light source, the second light source and the third light source,
wherein the beam splitter comprises:
a first prism that is provided so that the light beam from the first light source enters therein;
a second prism that is provided so that the light beam from the second light source enters therein;
a third prism that is provided so that the light beam from the third light source enters therein;
a first optical film that is formed between the first prism and the second prism; and
a second optical film that is formed between the first prism and the third prism,
wherein the first optical film has first optical characteristics for allowing the light beam from the first light source that enters into the first prism and has the first wavelength and the light beam from the second light source that enters into the second prism and has the second wavelength to pass through or for reflecting these light beams, and
the second optical film has second optical characteristics, which are different from the first optical characteristics, for allowing the light beam from the first light source that enters into the first prism and has the first wavelength, the light beam from the second light source that enters into the second prism and has the second wavelength and the light beam from the third light source that enters into the third prism and has the third wavelength to pass through or for reflecting these light beams.
